(19) United States
(12) Patent Application Publication
(10) Pub. No.: US 2008/0038142 A1
(43) Pub. Date: Feb. 14, 2008

(54) Method for Forming Powder Molding Product and Mold Apparatus for Powder Molding

(75) Inventors: Takashi Nakai, Gosen-shi (JP); Kinya Kawase, Niigata-shi (JP)

Correspondence Address: DARBY & DARBY P.C., P.O. BOX 770, Church Street Station, New York, NY, 10008-0770, US

(73) Assignee: Mitsubishi Materials PMG Corporation, Niigati-shi (JP)

(21) Appl. No.: 10/598,413

(22) PCT Filed: Feb. 24, 2005
(86) PCT No.: PCT/JP05/02994

§ 371 Date: Jun. 12, 2007

(30) Foreign Application Priority Data
Feb. 27, 2004 (JP) 2004-055363

(51) Int. Cl. B22F 3/035; B22F 3/02; B30B 11/00

(52) U.S. Cl. 419/56; 266/87

(57) ABSTRACT

A powder molding product may be formed by a forming portion in a mold body filled with a raw powder. Upper and lower punches are fitted into the forming portion to form the powder molding product. Prior to filling with the raw powder, aqueous solution in which water soluble lubricant having at least 3 g of solubility for 100 g of water is dissolved in water to uniform phase is applied to a mold portion. The aqueous solution is evaporated, thus forming a crystallized layer on the molding portion. The crystallized layer is formed on the peripheral surface of the molding portion for lubrication enabling the reducing of a pressure required for ejecting the powder molding product from the molding portion as well as the improving of the density of the powder molding product.

### CROSS REFERENCE TO PRIOR APPLICATION

This is a U.S. national phase application under 35 U.S.C. §371 of International Patent Application No. PCT/JP2005/002994 filed Feb. 24, 2005 and claims the benefit of Japanese Application No. 2004-055363, filed Feb. 27, 2004. The International Application was published in Japanese on Sep. 9, 2005 as International Publication No. WO 2005/082562 A1 under PCT Article 21(2).

### FIELD OF THE INVENTION

The present invention relates to a method for forming a powder molding product by filling raw powders in a mold for powder molding, and also relates to a mold apparatus for such powder molding.

### BACKGROUND ART

A compact powder, which is used for the production of sintered products, is formed by pressing raw powders such as Fe-based powders, Cu-based powders or the like in a mold, and then a sintered body is formed through a sintering process. And in the molding process, the molding product undergoes a press-molding process, using a mold. At the time of the press-molding, however, a friction between a molding product and a mold is generated. For this reason, when mixing powders, a water insoluble fatty acid lubricant, such as zinc stearate, calcium stearate, lithium stearate, etc., is added so as to impart lubricity.

However, the method of applying a lubricant to raw powders has limitations of improvement of the density of a molding product. Accordingly, in order to obtain a high-density molding product, there is proposed a method for forming a powder molding product which can make up for the lack of lubricity by applying the same lubricant as the one added to raw powders to a mold while reducing the amount of lubricant added to raw powders (for example, see Patent Document 1).

This conventional method of molding is a method for forming powder molding product which comprises steps of applying water dispersed in a high fatty acid lubricant to an inner surface of a heated mold and press-molding metal powders by filling the metal powders in the mold and pressing the same at such a pressure that the high fatty acid lubricant is chemically bonded to the metal powders so as to produce a film of metallic soap, wherein the mold is heated, and the inner surface thereof is coated with the high fatty acid lubricant such as lithium stearate; heated metal powders are filled into this mold and are subjected to press-molding at such pressure that the high fatty acid lubricant is chemically bonded to the metal powders so as to produce the film of metallic soap, whereby the film of metallic soap is produced on the inner surface of the mold to thereby reduce the friction between the molding product of the metallic powders and the mold, thereby enabling the reduction of pressure for ejecting the molding product.

As the fact that the same lubricant as one added to the raw powders is used for the mold results in the use of the water insoluble lubricant, the lubricant applied to the mold is applied in a solid powder state. For this reason, other lubricant application methods are also known, such as electrostatic application of lubricant powders or dry application of lubricant which is dispersed in water by surfactant.

### SUMMARY OF THE INVENTION

According to the conventional art disclosed in Japanese Registered Patent Publication No. 3309970 since the lubricant dispersed in water is applied to the mold in a state of solid powders, that is, in such state that the solid powders of the lubricant are dispersed and mixed in water, a fine and uniform film cannot be formed, and thus there is a problem that producing a molding product of a stable quality is difficult.

The present invention has been made to solve the above problems. The same applicant proposes in the Japanese Patent Application No. 2002-338621, a method for forming a powder molding product by filling a molding portion formed in a mold body with a raw powder and then fitting punches into the molding portion, comprising the steps of applying an aqueous solution obtained by dissolving a lubricant in solvent to the molding portion prior to filling the molding portion with a raw powder, and evaporating the aqueous solution thus applied to thereby form a crystallized layer on the molding portion which enables producing a fine and uniform layer of lubricant on a molding portion by said crystallized layer. And optimum aqueous solution is obtained by the more and more development of crystallized layer.

It is, accordingly, an object of the present invention to provide a method for forming a powder molding product and mold apparatus for powder molding which enables the stable production of a high density powder molding product by forming a fine and uniform film of lubricant on a molding portion.

An aspect of the present invention is a method for forming a powder molding product by filling a molding portion formed in a mold body with a raw powder and then fitting punches into the molding portion, which is characterized in that applying an aqueous solution obtained by dissolving a water soluble lubricant having at least 3 g of solubility for 100 g of water at 20° C. in a water to the molding portion prior to filling the molding portion with a raw powder, and evaporating the aqueous solution thus applied to thereby form a crystallized layer on the molding portion.

Further, embodiments are that said lubricants are used at least one selected from a group of oxo-acid based metal salts or organic acid based metal salts. In an embodiment aqueous solution is completely dissolved in water to have a concentration greater than or equal to 0.01% by weight concentration but less than saturated concentration, and lubricant is potassium salt or sodium salt.

Further, embodiments add an antiseptic substance, a defoaming agent and a water soluble solvent into said lubricant. Also the aqueous solvent can be alcohol or ketone. Further, halogen elements can be excluded from the lubricant.

With regard to a method for forming a powder molding product, for example, by completely dissolving water soluble phosphate based metal salt such as dipotassium hydrogen phosphate, disodium hydrogen phosphate in water to have a concentration greater than or equal to 0.01% by weight but less than a saturated concentration at a friction surface of molding product, to become a uniform phase, then applying a solution to a surface of a molding portion, and evaporating, the crystal of the lubricant grows to form a crystallized layer.

Further, an embodiment of the invention is a mold apparatus for powder molding, having a mold body with a through-hole for forming a side of a powder molding product, a lower punch to be fitted into the through-hole from beneath, an upper punch to be fitted into the through-hole from above, a spray member from which a lubricant aqueous solution is faced into the through-hole, a heater provided around a molding portion of the powder molding product, the molding portion being defined by the through-hole and the lower punch which is fitted into the through-hole, and a temperature control system keeping a temperature of the heater higher than an evaporating temperature of the aqueous solution.

Furthermore, another embodiment is a mold apparatus for powder molding, having a mold body with a through-hole for molding a side of a powder molding product, a lower punch to be fitted into the through-hole from beneath, an upper punch to be fitted into the through-hole from above, a spray member from which a lubricant aqueous solution is faced into the through-hole, a heater provided around a molding portion of the powder molding product, the molding portion being defined by the through-hole and the lower punch which is fitted into the through-hole, a temperature control system keeping a temperature of the heater higher than an evaporating temperature of the aqueous solution, but lower than a melting temperature of said lubricant.

According to the above, an aqueous solution in which water soluble lubricant having at least 3 g of solubility for 100 g of water at 20° C. is applied to the heated molding portion prior to a raw powder being filled in the molding portion defined by the through-hole in the mold body and the lower punch to be fitted into the through-hole, so that the solution is evaporated to thereby form a fine crystallized layer around the surface of the molding portion. Thereafter, the molding portion is filled with a raw powder, and then the upper punch is fitted from above into the through-hole, to thereby form a powder molding product.

The present invention can be a method for forming a powder molding product by filling a molding portion formed in a mold body with a raw powder and then fitting punches into the molding portion, which is characterized in that applying an aqueous solution obtained by dissolving a lubricant in solvent to the molding portion prior to filling the molding portion with a raw powder, and evaporating the aqueous solution thus applied to thereby form a crystallized layer on the molding portion. By forming more fine and uniform crystallized layer for lubrication, the reduction of a pressure for ejecting the powder molding product as well as the improvement of the density of the powder molding product can be obtained.

Further, an aspect of the invention is that the lubricant is oxo-acid based metal salt.

Further, an embodiment of the present invention is that said lubricant is phosphate metal salt, sulfate metal salt, borate metal salt, silicate metal salt, tungstate metal salt, organic acid based metal salt, nitrate metal salt or carbonate metal salt. Alternatively, the said lubricant is dipotassium hydrogen phosphate, disodium hydrogen phosphate, tripotassium phosphate, trisodium phosphate, potassium polyphosphate, sodium polyphosphate, riboflavin potassium phosphate and riboflavin sodium phosphate. Also, the lubricant can be potassium sulfate, sodium sulfate, potassium sulfite, sodium sulfite, potassium thiosulfate, sodium thiosulfate, potassium dodecyl sulfate, sodium dodecyl sulfate, potassium dodecyl benzen sulfate, sodium dodecyl benzene sulfate, Food Blue No. 1., Food Yellow No. 5., potassium ascorbyl sulfate ester and sodium ascorbyl sulfate ester.

An embodiment is that the lubricant is potassium tetraborate or sodium tetraborate. Alternately, the lubricant is potassium silicate, sodium silicate. potassium tungstate, sodium tungstate, potassium acetate, sodium acetate, potassium benzoate, sodium benzoate, dipotassium terephthalate, disodium terephthalate, potassium ascorbate, or sodium ascorbate. Also, an embodiment of the present invention is that the lubricant is potassium nitrate, sodium nitrate, potassium carbonate, sodium carbonate, potassium hydrogen carbonate, or sodium hydrogen carbonate. Furthermore, the lubricant uses one or more lubricants described above. The aqueous solution can be one in which said lubricant is completely dissolved in water to have a concentration greater than or equal to 0.01% by weight but less than saturated concentration. The lubricant can be potassium salt or sodium salt and an antiseptic substance or a defoaming agent can be added into the lubricant. Further, a water soluble solvent is added into the lubricant and the said solvent is alcohol or ketone. Also, an embodiment is that no halogen element is included in the lubricant.

The present invention includes a mold apparatus for powder molding, having a mold body with a through-hole for forming a side of a powder molding product, a lower punch to be fitted into the through-hole from beneath, an upper punch to be fitted into the through-hole from above, a spray member from which a lubricant solution is faced into the through-hole, a heater provided around a molding portion of the powder molding product, the molding portion being defined by the through-hole and the lower punch which is fitted into the through-hole, a temperature control system keeping a temperature of the heater higher than an evaporating temperature of the aqueous solution, and if required lower than a melting temperature of said lubricant; and an aqueous solution in which water soluble lubricant having at least 3 g of solubility for 100 g of water at 20° C. is dissolved in water, is provided in said spray member. By forming a crystallized layer of lubricant on a molding portion, the reduction of a pressure for ejecting the powder molding product, or the improvement of the density of the powder molding product can be obtained. Further, consecutive molding can be stably carried out.

### BRIEF DESCRIPTION OF THE DRAWINGS

FIG. 1 is a cross sectional diagram showing a first process according to an Example 1 of the present invention.

FIG. 2 is a cross sectional diagram showing a second process according to an Example 1 of the present invention.

FIG. 3 is a cross sectional diagram showing a third process according to an Example 1 of the present invention.

FIG. 4 is a cross sectional diagram showing a forth process according to an Example 1 of the present invention.

FIG. 5 is a solubility diagram of a soap.

FIG. 6 is a cross sectional diagram showing a first process according to an Example 2 of the present invention.

FIG. 7 is a cross sectional diagram showing a second process according to an Example 2 of the present invention.

FIG. 8 is a cross sectional diagram showing a third process according to an Example 2 of the present invention.

FIG. 9 is a cross sectional diagram showing a fourth process according to an Example 2 of the present invention.

FIG. 10 is a cross sectional diagram showing a first process according to an Example 3 of the present invention.

FIG. 11 is a cross sectional diagram showing a second process according to an Example 3 of the present invention.

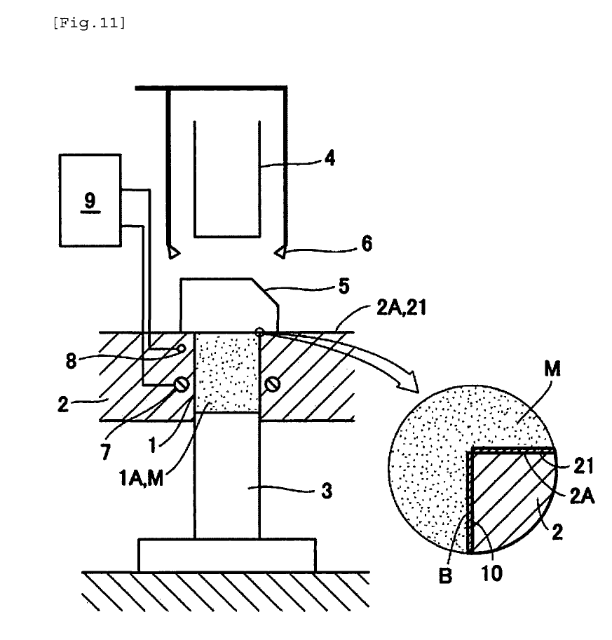

FIG. 12 is a cross sectional diagram showing a first process according to an Example 4 of the present invention.

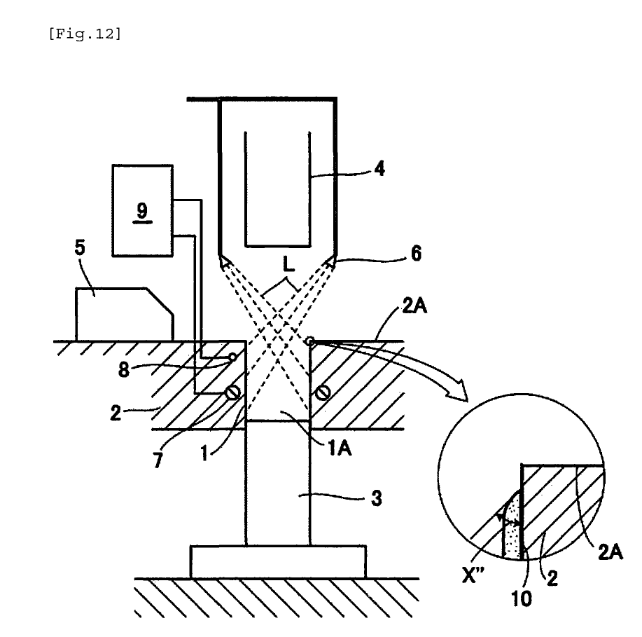

FIG. 13 is a cross sectional diagram showing a second process according to an Example 4 of the present invention.

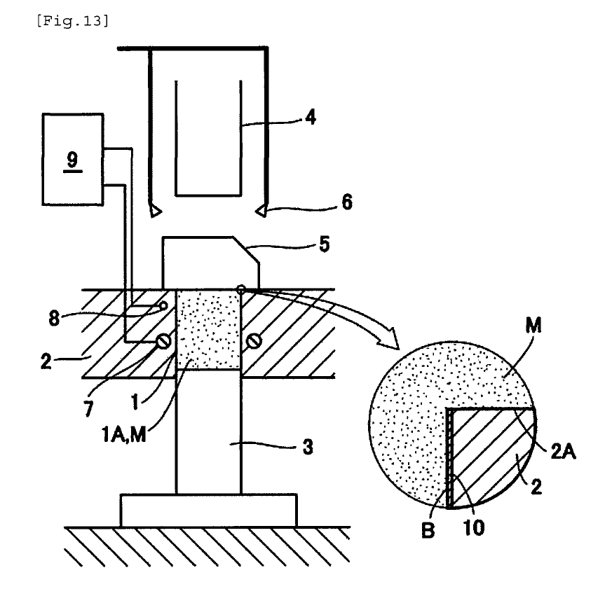

### DETAILED DESCRIPTION OF THE INVENTION

Suitable embodiments of the present invention will now be explained with reference to attached drawings. Further, it should be understood that the embodiments explained below are not limited to the scope of the present invention described in claims. And, it should be understood that the total constitution described below is not essential requirement for the present invention.

### EXAMPLE 1

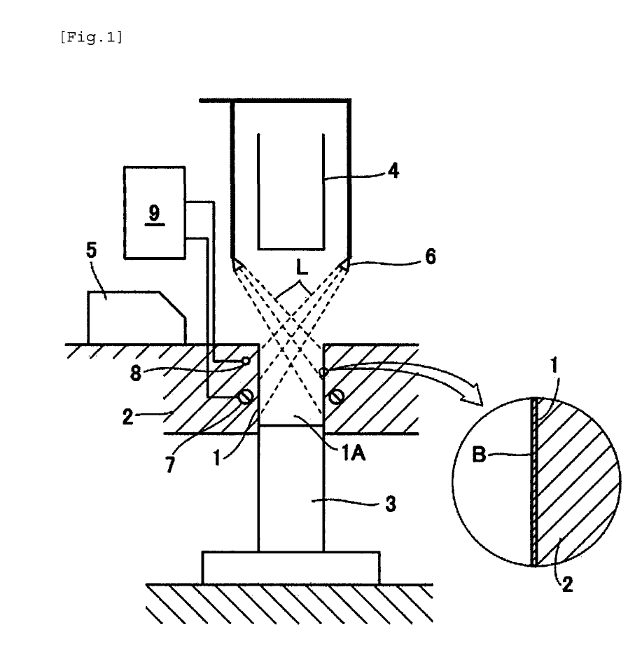

Example 1 of the present invention will now be explained with reference to FIGS. 1 to 4. FIG. 1 represents a first process. According to the same Figures, numeral 1 designates a through-hole formed in a die 2 serving as a mold for molding sides of a powder molding product A, i.e., compact as a later-described powder molded body. A lower punch 3 is fitted into the through-hole from the underneath thereof and an upper punch 4 is also fitted into the through-hole 1 from the above thereof. A feeder 5, which provides a raw powder M, is slidably provided on an upper surface of the die 2. Above the through-hole 1 is provided a spray member 6 serving as a solution applying means for spraying a lubricant solution L so as to attach the same to a molding portion 1A of the mold. The spray member 6 is arranged so as to face the through-hole 1, and is connected to a tank of the solution L (not shown) via an automatically openable and closable valve (not shown) . A heater 7 and a temperature detector 8 are provided around the periphery of the molding portion 1A for forming the powder molding product A, the molding portion being defined by the through-hole 1 and the lower punch 3 which is fitted into the through-hole. The heater 7 and the temperature detector 8 are connected to a temperature control device 9 serving as a temperature controlling means. By the temperature control device 9, the temperature of through-hole 1 is kept higher than the evaporating temperature of the aqueous solution L, and lower than the melting temperature of the lubricant.

In the first process, due to the heat of the heater 7 being pre-controlled by the temperature control system 9, the temperature of the periphery of the through-hole 1 is kept higher than the evaporating temperature of the aqueous solution L, and lower than the melting temperature of the lubricant. Then, the automatically openable and closable valve is opened to apply the aqueous solution L in which water soluble lubricant having at least 3 g of solubility for 100 g of water at 20° C. is dissolved in water by spraying from the spray member 6 to the molding portion 1A of the die 2 heated by the heater 7, with the lower punch 3 being fitted into the through-hole 1 to define the molding portion 1A. As a result, the solution L is evaporated and dried out, and thus crystals are allowed to grow on the peripheral surface of the through-hole 1, so that a crystallized layer B of the lubricant is uniformly formed. Using a water soluble lubricant having at least 3 g of solubility for 100 g of water at 20° C. can be produced precipitate in an aqueous solution around the room temperature. Therefore, trouble such as the clogging of the spray member 6 is occurred when applying by spray member 6. Meanwhile, for example, if an aqueous solution does not keep a higher temperature, conventional higher fatty acidic soaps comprising sodium stearate, sodium palmitate, sodium myristate, sodium laurate cannot be obtained at least 3 g of solubility for 100 g of water.

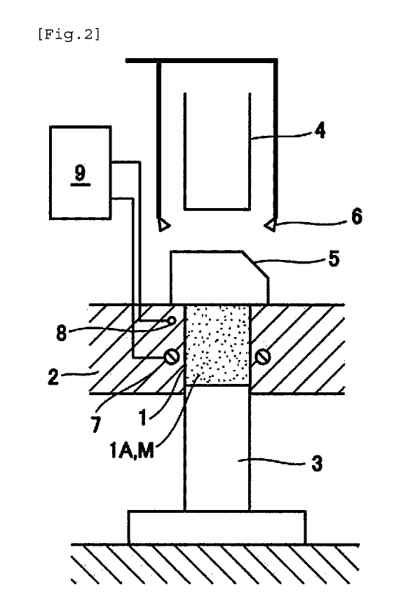

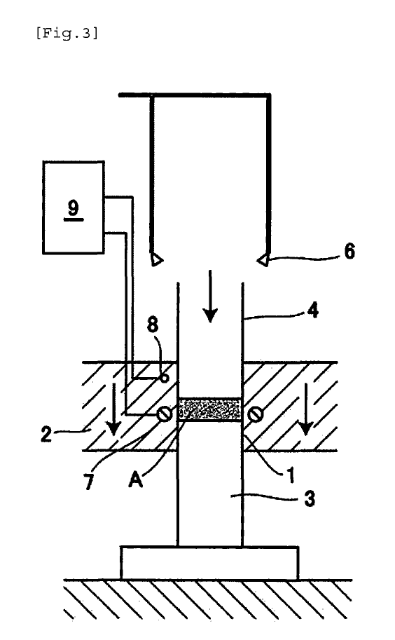

Next, as illustrated in a second process shown in FIG. 2, the feeder 5 is moved forward so as to drop a raw powder M into the molding portion 1A to fill the same therewith. Subsequently, as illustrated in a third process shown in FIG. 3, the die 2 is moved downwardly, while the upper punch 4 is inserted into the molding portion 1A of the through-hole 1 from there above, so that the raw powder M is compressed in a manner that is sandwiched between the upper punch 4 and the lower punch 3. At this stage, a bottom end of the lower punch 3 is firmly held in position. And in this third process, the material powder M is compressed as the state of lubrication by being pressed against the crystallized layer B formed of the lubricant

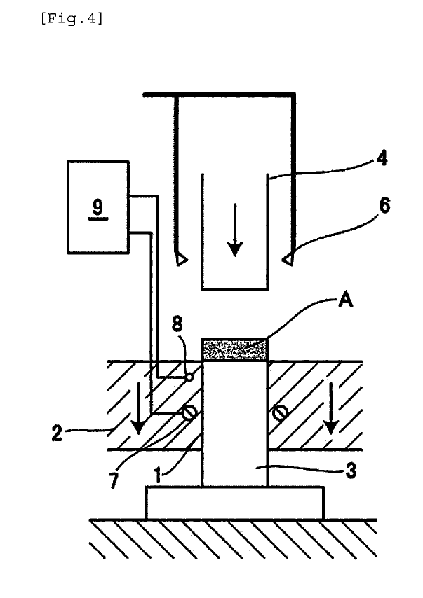

The powder molding product A thus press-molded becomes ejectable when the die 2 is moved further downwardly until the upper surface of the die 2 becomes essentially as high as the lower surface of the lower punch 3, as illustrated in a fourth process shown in FIG. 4. When ejecting the same, the powder molding product A is allowed to contact the crystallized layer B that is formed of the lubricant and is in a lubricated condition. After ejecting the powder molding product A thus way, the first process is repeated and thus the aqueous solution L is applied to the molding portion 1A again to form the crystallized layer B, and then the raw powder M is filled into the molding portion 1A.

Next, as to a good water solubility, it will be explained the point that the solubility is at least 3 g of solubility for 100 g of water at 20° C. As can be seen from the solubility for various fatty acid soaps illustrated in FIG. 4, the solubility of the mixed soaps which is produced by animal oil or vegetable oil or main components thereof are very lower at room temperature, thus even though it is dissolved in water the precipitates are generated in a few minutes. And at about 20° C., which is used commonly as room temperature, the precipitates are generated. Therefore inconvenience such as the clogging of the spray member is occurred. In this regard, the recognition that these component should not be included makes the solubility in 100 g water at 20° C. is at least 3 g.

Preferred examples and comparative examples will now be explained with reference to Tables 1 to 3. In each of the preferred examples and comparative examples shown in Tables 1 to 3, iron powders (average particle diameter: 90 μm) were used as the raw powder, to which was added 0.2% by weight of Lithium stearate (average particle diameter: 5 82 m) serving as the lubricant, which were then mixed for 30 minutes using a rotary mixer, so that 7 g of the resultant mixture of the raw powder was filled into a mold forming a cylindrical column having a 1 cm² pressurization area, and then 100 powder molding products were successively formed at a molding pressure of 8 t/cm². And in the examples, after the aqueous solution of the water-soluble lubricant dissolved in water was applied to the molding portion heated at 150° C. in the mold, it was evaporated and dried to form the crystallized layer, and then the raw powders were filled into this molding portion. In the comparative example 1, after the solution of lithium stearate (average particle diameter: 5 μm) dispersed in acetone was applied to the molding portion of the mold heated at 150° C., it was dried to form the film, and then the raw powders were filled into this molding portion. The comparative example 2 is a case in which the lubricant was not applied to the mold. Density R in each Table shows difference between maximum and minimum values in the density of 100 molding bodies continuously molded.

TABLE 1

| | Example 1 | Example 2 | Example 3 | Example 4 | Example 5 | Example 6 | Example 7 | Example 8 | Example 9 |
|---|---|---|---|---|---|---|---|---|---|
| Mold | Dipotassium | Disodium | Trisodium | Sodium | Riboflavin | potassium | sodium | sodium | Sodium |
| lubricating | hydrogen | hydrogen | phosphate | polyphosphate | sodium | sulfate | sulfite | thiosulfate | dodecylsulfate |
| component | phophate | phophate | | | phosphate | | | | |
| Solvent | Water | Water | Water | Water | Water | Water | Water | Water | Water |
| State of | dissolved | dissolved | dissolved | dissolved | dissolved | dissolved | dissolved | dissolved | dissolved |
| lubricating | | | | | | | | | |
| component | | | | | | | | | |
| Concentration | 1% | 1% | 1% | 1% | 1% | 1% | 1% | 1% | 1% |
| Molding | 150° C. | 150° C. | 150° C. | 150° C. | 150° C. | 150° C. | 150° C. | 150° C. | 150° C. |
| temperature | | | | | | | | | |
| Average | 6 kN | 8 kN | 6 kN | 8 kN | 20 kN | 18 kN | 20 kN | 18 kN | 16 kN |
| ejecting | | | | | | | | | |
| pressure | | | | | | | | | |
| Average molding | 7.56 g/cm³ | 7.55 g/cm³ | 7.56 g/cm³ | 7.54 g/cm³ | 7.5 g/cm³ | 7.52 g/cm³ | 7.5 g/cm³ | 7.51 g/cm³ | 7.53 g/cm³ |
| product density | | | | | | | | | |
| Density R | 0.02 | 0.02 | 0.02 | 0.02 | 0.03 | 0.02 | 0.02 | 0.02 | 0.03 |

TABLE 2

| | | | | | | | | | Example |
|---|---|---|---|---|---|---|---|---|---|
| | Example 10 | Example 11 | Example 12 | Example 13 | Example 14 | Example 15 | Example 16 | Example 17 | 18 |
| Mold lubricating | Sodium | Food Blue | Food Yellow | Sodium | sodium | sodium | sodium | sodium | Sodium |
| component | dodecylbenzene- | No. 1 | No. 5 | ascorbyl | tetraborate | silicate | tungstate | acetate | benzoate |
| | sulfonate | | | sulfate | | | | | |
| Solvent | Water | Water | Water | Water | Water | Water | Water | Water | Water |
| State of | dissolved | dissolved | dissolved | dissolved | Dissolved | dissolved | dissolved | dissolved | dissolved |
| lubricating | | | | | | | | | |
| component | | | | | | | | | |
| Concentration | 1% | 1% | 1% | 1% | 1% | 1% | 1% | 1% | 1% |
| Molding | 150° C. | 150° C. | 150° C. | 150° C. | 150° C. | 150° C. | 150° C. | 150° C. | 150° C. |
| temperature | | | | | | | | | |
| Average ejecting | 16 kN | 16 kN | 20 kN | 8 kN | 8 kN | 10 kN | 12 kN | 18 kN | 10 kN |
| pressure | | | | | | | | | |
| Average molding | 7.53 g/cm³ | 7.53 g/cm³ | 7.51 g/cm³ | 7.54 g/cm³ | 7.54 g/cm³ | 7.54 g/cm³ | 7.53 g/cm³ | 7.51 g/cm³ | 7.54 |
| product density | | | | | | | | | g/cm³ |
| Density R | 0.02 | 0.03 | 0.04 | 0.02 | 0.02 | 0.03 | 0.03 | 0.02 | 0.02 |

TABLE 3

| | | | | | | Comparative | Comparative |
|---|---|---|---|---|---|---|---|
| | Example 19 | Example 21 | Example 23 | Example 24 | Example 25 | Example 1 | Example 2 |
| Mold | Disodium | Sodium | Sodium | Sodium | Potassium | Lithium | None |
| lubricating | terephthalate | stearate | hydrogen | carbonate | nitrate | stearate | |
| component | | | carbonate | | | | |
| Solvent | Water | Water | Water | Water | Water | acetone | |
| State of | dissolved | dissolved | dissolved | dissolved | dissolved | dispersed | |
| lubricating | | | | | | | |
| component | | | | | | | |
| Concentration | 1% | 0.2% | 1% | 1% | 1% | 1% | |
| Molding | 150° C. | 150° C. | 150° C. | 150° C. | 150° C. | 150° C. | 150° C. |
| temperature | | | | | | | |
| Average | 1 kN | 16 kN | 18 kN | 18 kN | 20 kN | 22 kN | 32 kN |
| ejecting | | | | | | | |
| pressure | | | | | | | |
| Average molding | 7.54 g/cm³ | 7.52 g/cm³ | 7.51 g/cm³ | 7.52 g/cm³ | 7.51 g/cm³ | 7.5 g/cm³ | 7.48 g/cm3 |
| product density | | | | | | | |
| Density R | 0.02 | 0.04 | 0.03 | 0.02 | 0.04 | 0.02 | 0.16 |

Comparison result from Tables 1 to 3 indicates that the pressure required for ejecting a compact from a die in the examples were less than or equal to that of the comparative example 1. Besides, the densities were improved in the examples as compared to the comparative example 1. Moreover, the densities R in the examples noticeably became smaller than that of the comparative example 1. Therefore, it is apparent from the result that the molding can be stably carried out according to the examples, even though it is carried out successively.

As is clearly indicated in Tables 1 to 3, the aforesaid lubricant may suitably be a water soluble phosphate based metal salt, and the one having a phosphate group in its structure, such as dipotassium hydrogen phosphate, disodium hydrogen phosphate, tripotassium phosphate, trisodium phosphate, potassium polyphosphate, sodium polyphosphate, riboflavin potassium phosphate, riboflavin sodium phosphate or the like.

As is also seen from Tables 1 to 3, it is suitable that, as a water soluble sulfate-based metal salt, the lubricant may include a sulfate-based group in its structure, such as potassium sulfate, sodium sulfate, potassium sulfite, sodium sulfite, potassium thiosulfate, sodium thiosulfate, potassium dodecyl sulfate, sodium dodecyl sulfate, potassium dodecylbenzensulfate, sodium dodecylbenzenesulfate, Food Blue No. 1. (C₃₇H₃₄N₂Na₂O₉S₃), Food Yellow No. 5. (C₁₆ H₁₀ N₂ Na₂O₇S₂), potassium ascorbyl sulfate, sodium ascorbyl sulfate.

As is also seen from Tables 1 to 3, it is suitable that, as a water soluble borate based metal salt, the lubricant may include a borate-based group in its structure, such as potassium tetraborate, sodium tetraborate.

Tables 1 to 3 also show that as a water soluble silicate based metal salt, the lubricant may suitably include a silicate-based group in its structure, such as potassium silicate, sodium silicate.

Still also, Tables 1 to 3 show that as a water soluble tungstate based metal salt, the lubricant may suitably include a tungstate-based group in its structure, such as potassium tungstate or sodium tungstate.

Table 1 to 3 show that as a water soluble organic acid based metal salt, the lubricant may suitably include an organic acid based group in its structure, such as potassium acetate, sodium acetate, potassium benzoate, sodium benzoate, dipotassium terephthalate, disodium terephthalate, potassium ascorbate, or sodium ascorbate.

It is also seen from Tables 1 to 3, that as a water soluble nitrate based metal salt, the lubricant may suitably include a nitrate-based group in its structure such as potassium nitrate, sodium nitrate.

It is still also seen from Tables 1 to 3 that as a water soluble carbonate-based metal salt, the lubricant may suitably include a carbonate based group in its structure, such as potassium carbonate, sodium carbonate, potassium hydrogen carbonate or sodium hydrogen carbonate.

Alternatively, one or more of the foregoing lubricants may be used as the lubricant.

And the water soluble lubricant should have a concentration greater than or equal to 0.01% by weight but less than a concentration of a saturation. This is because the concentration of less than 0.01% by weight makes it difficult to obtain a stably forming with constant temperature and speed since water content to apply and evaporate on the mold for forming is too large quantities and thus the mold temperature is lower, while at the saturated concentration or above it does not allow the lubricant to be completely dissolved so that it is precipitated as a solid, thus casing troubles such as the clogging of the spray member 6 when applying lubricant by a spray member 6.

For dissolvent water, water from which metal and halogen elements are removed is preferable, such as distilled water or ion exchange water. This is because some lubricants, though it depends on a kind thereof, are precipitated due to the readiness to substitute metal components in water, thus casing troubles, while water containing a large amount of halogen components is likely to cause a bond to a compact or to produce a harmful substance such as dioxin or the like during a sintering process.

Further, some lubricants, though also depending on a kind thereof, facilitate the growing of microorganisms and thus the solution is easily decayed, thereby causing a change in components, emitting bad smell. However, adding an antiseptic agent can prevent the growing of microorganisms. For the antiseptic agent, it is preferable to use one which does not impair lubrication property, produces low harmful effects to a human body, and includes no halogen components, such as sodium benzoate or the like.

Furthermore, some lubricants have a problem that foaming easily occurs, and thus when the aqueous solution (L) is applied to the molding portion (1A), such molding is likely to occur foaming so that a raw powder is caked. However, by adding a water-soluble solvent such as alcohol or ketone, or a defoaming agent, such foaming can be prevented. For alcohol or ketone, it is preferable to use one which does not impair the lubricating action, causes less damages to a human body, and does not include halogen components, such as ethanol, acetone or the like.

In some cases, using a water soluble solvent such as alcohol and ketone with a lower boiling point or a lower latent heat of evaporation than water can reduce hours for evaporation or dry, eliminating the need for keeping the mold body 2 at high temperature.

In a case where these lubricants, additives or dissolvent water include halogen elements, a substance that is highly toxic even in minute amounts such as dioxin is likely to be created under such a condition that sintering is performed with carbon components being coexistent, as is often used in powder metallurgy of iron. Therefore it is preferable to include no halogen elements therein.

As for the temperature of the mold body 2 and the mixed raw powder M, keeping them at high temperature is desirable because it contributes to reduction of hours for drying, accompanied by effects of warm molding and the like. If there is caused no particular trouble, however, it can be kept at ordinary temperature. On the other hand, when setting them at high temperature, it is preferable to choose such a lubricant that is not melt down at a preset temperature, since the melt lubricant makes it difficult to stably perform warm molding due to the melt lubricant caking a raw powder, flowing down to the bottom of the mold (the molding portion 1A). If there is caused no particular trouble, however, it may be in a semi-molten state, in a highly viscous state, or otherwise, at least one lubricant of the mixed two ore more lubricants may be in a molten state. Since zinc stearate and lithium stearate that have been conventionally used have melting temperatures of about 120° C. and about 220° C., respectively, it has heretofore been difficult to stably perform warm molding at a temperature higher than these temperatures. Among the lubricants proposed in the present invention, however, there are a number of lubricants that have a higher melting point than 220° C., and some of them have a higher melting point than 1000° C. Therefore it is possible to easily and stably perform warm molding by raising the temperature almost to an oxidization temperature of the raw powder or heat resistance of mold (molding portion A). In that case, however, there occur problems such as fluidity of the raw powder, and thus it is preferable to use the lubricant that does not melt even under high temperature, as the one to be added into the mixed raw powder M. For example, the powdery lubricants of the present invention or solid lubricants such as graphite or molybdenum disulfide which can be used a high temperature of at least 200° C. are preferable. Alternatively, it is also preferable to mold only by lubrication of the mold itself without using the lubricant into raw powder.

According to the description of the foregoing embodiment, there is provided a method for forming a powder molding product, comprising a filling the molding portion 1A in the mold body 2 with the raw powder M, and then inserting upper and lower punches 3, 4 into the molding portion 1A to thereby form the powder molding product, wherein prior to filling the molding portion 1A with the raw powder M, the aqueous solution L in which lubricant is dissolved in a solvent is applied to the molding portion 1A to a uniform phase, and then the aqueous solution L is evaporated to thereby form a crystallized layer B on the molding portion 1A. Thus, the fine and uniform layer B for lubrication is formed on the peripheral surface of the molding portion 1A, thereby enabling the reducing of a pressure required for ejecting the powder molding product A from the molding portion 1A as well as the improving of the density of the powder molding product A.

Also, there is provided a mold apparatus for powder molding, comprising the mold body 2 with the through-hole 1 for molding a side of the powder molding product A, the lower punch 3 to be fitted into the through-hole 1 from beneath, the upper punch 4 to be fitted into the through-hole 1 from above, the spray member 6 from which the lubricant aqueous solution L is faced into the through-hole 1, the heater 7 provided around the molding portion 1A of the powder molding product A, the molding portion 1A being defined by the through-hole 1 and lower punch 3 which is fitted into the through-hole 1, and the temperature control system 9 keeping a temperature of the heater 7 higher than an evaporating temperature of the aqueous solution L, if required but lower than a melting temperature of said lubricant. And prior to filling the molding portion 1A with the raw powder M, the lubricant aqueous solution L is applied to the molding portion 1A which is heated, and then the aqueous solution L is evaporated to thereby form the fine and uniform crystallized layer B on the peripheral surface of the molding portion 1A. Thus, the fine and uniform crystallized layer B for lubrication is formed on the peripheral surface of the molding portion 1A, thereby enabling the reducing of a pressure required for ejecting the powder molding product A from the molding portion 1A as well as the improving of the density of the powder molding product A, and realizing the stable and successive molding.

### EXAMPLE 2

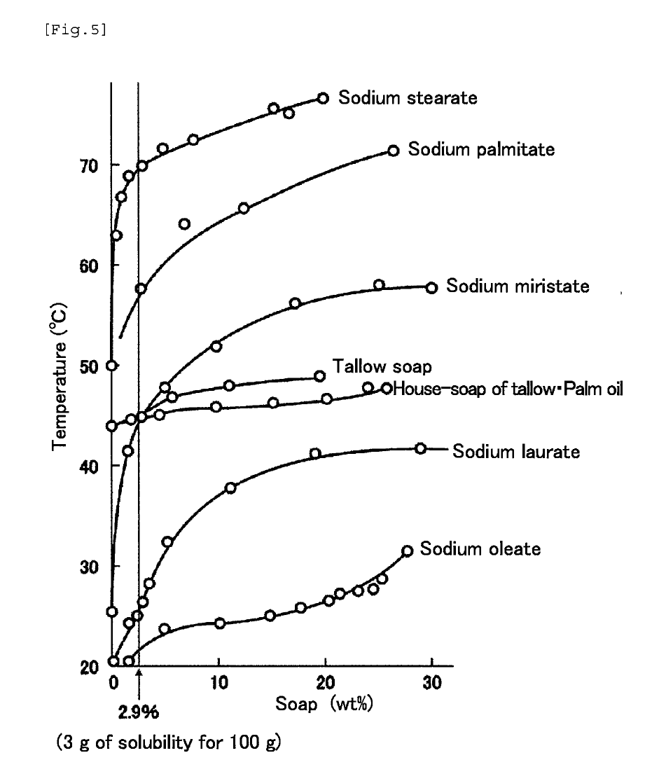

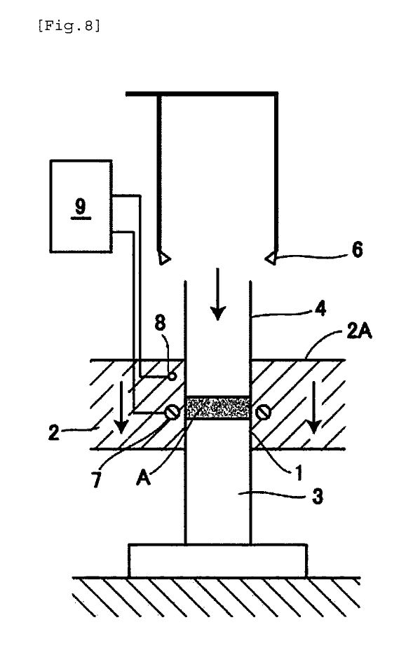

FIG. 5-FIG. 8 represent example 2. in which the same reference symbols as Example 1 will be designated by the same symbols, and their repeated detailed description will be omitted. A surface 10 of the through-hole 1 is formed with a surface treatment layer 11 by hydrophilicity imparting treatment to the surface 10 for improving the wetting action of the aqueous solution L relative to the surface 10, or by arranging hydrophilic material thereon. An angle X of contact of the surface treatment layer 11 relative to the aqueous solution L is smaller than an angle Y of contact of the surface 10, which is made from the material of the die 2 itself, or of the upper surface 2A where the material is exposed, relative to the aqueous solution L (X<Y), thus enabling the said wetting action to be improved. Further, it should be noted herein that these angles of contact X, Y are not measured under such condition as shown in figure which are only schematically illustrated for the sake of explanation, but are measured under an equal condition, such as keeping the surface 10 and the upper surface 2A horizontally. And the surface treatment layer 11 is formed by: the thermal spraying, PVD, CVD or shot peening of oxide, fluoride, nitride, chloride, sulfide, bromide, iodide, carbide, hydroxide and etc. having bonds as shown in Table 4 to hydrophilic coating, subjecting the coating of titania, zinc oxides or the like to photocatalytic reaction by irradiating light thereto, creating hydroxide by alkali or hydrothermal treatment, the surface treatment by sputtering with potassium ions or sodium ions, and utilizing change in surface tension of the aqueous solution L by the formation of minute pores on the surface by spray coating or powder metallurgy die, whereby the surface treatment layer thus obtained allows the angle of contact of the solution relative to the surface 10 of the through-hole 1 to be made smaller, thereby improving the wetting action of the solution therein. Alternatively, the surface 10 of the through-hole 1 may undergo the removal of oily organisms through acid or flame processing, electrolytic polishing etc so that the angle of contact X may become small. If there causes no problem in strength, the die may preferably be formed from hydrophilic materials shown in Table 4. Alternatively, metals such as iron or hard metal may have the substances shown in Table 1 dispersed therein to improve strength and hardness. Alloying with easily oxidizable metals such as Ti, V, Si, and Al, etc. to use as the material of the die is also effective to improve hydrophilic property. In the case of coating, the coating of iron or hard metal together with hydrophilic materials in order to improve strength and hardness is desirable since such coating can satisfy both the long-duration and hydrophilicity of the die.

TABLE 4
Examples of Hydrophllic Substances

| | Approximate | Pricipal Reason for |
|---|---|---|
| Hydrophllic Bond Elements or Hydrophillic Substances | ionicity Bond | Hydrophllic Property |
| Cs—F, Fr—F | 93% | due to large ioncity |
| K—F, Rb—F | 92% | (polarity) of Bonds |
| Na—F, Ba—F, Ra—F | 91% | |
| Li—F, Ca—F, Sr—F | 89% | |
| Ac—F, lanthanoid-F | 88% | |
| Mg—F, Y—F, Cs—O, Fr—O | 86% | |
| Se—F, Hf—F, Th—F, K—O, Rb—O | 84% | |
| Zr—F, Pa—F, U—F, Na—O, Ba—O, Ra—O | 82% | |
| Be—F, Al—F, Ti—F, Ta—F, Mn—F, Li—O, Ca—O, Sr—O | 79% | |
| Nb—F, V—F, Cr—F, Zn—F, Ga—F, Ac—O, lanthanoid-O | 76% | |
| W—F, Cd—F, In—F, Mg—O, Y—O, Cs—O, Fr—O, Cs—N, Fr—N, Cs—Cl, Fr—Cl | 73% | |
| Mo—F, Fe—F, Tl—F, Si—F, Ge—F, Sn—F, Se—O, Hf—O, Th—O, K—N, Rb—N, K—Cl, Rb—Cl | 70% | |
| Re—F, Tc—F, Co—F, Ni—F, Cu—F, Ag—F, Hg—F, Pb—F, Sb—F, Bi—F, Zr—O, Pa—O, | 67% | |
| U—O, Na—N, Ba—N, Ra—N, Na—Cl, Ba—Cl, Ra—Cl, Cs—Br, Fr—Br | | |
| B—F, As—F, Po—F, Be—O, Al—O, Ti—O, Ta—O, Mn—O, Li—N, Ca—N, Sr—N, Li—Cl, | 63% | |
| Ca—Cl, Sr—Cl, K—Br, Rb—Br P—F, Te—F, Nb—O, V—O, Cr—O, Zn—O, Ga—O, Ac—N, | | |
| lanthanoid-N, Ac—Cl, lanthanoid-Cl, Na—Br, Ba—Br, Ra—Br | | |
| P—F, Te—F, Nb—O, V—O, Cr—O, Zn—O, Ga—O, Ac—N, lanthanoid-N, Ac—Cl, lanthanoid-Cl, | 59% | |
| Na—Br, Ba—Br, Ra—Br | | |
| Ru—F, Os—F, Rh—F, Ir—F, Pd—F, Pt—F, At—F, W—O, Cd—O, In—O, Mg—N, Y—N, Cs—N, | 55% | |
| Fr—N, Mg—Cl, Y—Cl, Cs—Cl, Fr—Cl, Li—Br, Ca—Br, Sr—Br, Cs—C, Fr—C, Cs—S, Fr—S, | | |
| Cs—I, Fr—I | | |
| Mo—O, Fe—O, Tl—O, Si—O, Ge—O, Sn—O, Se—N, Hf—N, Th—N, Se—Cl, Hf—Cl, Th—Cl, Ac—Br, | 51% | |
| lanthanoid-Br, K—C, Rb—C, K—S, Rb—S, K—I, Rb—I | | |
| Au—F, Se—F, Re—O, Tc—O, Co—O, Ni—O, Cu—O, Ag—O, Hg—O, Pb—O, Sb—O, Bi—O, Zr—N, | 47% | |
| Pa—N, U—N, Zr—Cl, Pa—Cl, U—Cl, Mg—Br, Y—Br, Na—C, Ba—C, Ra—C, Na—S, Ba—S, | | |
| Ra—S, Na—I, Ba—I, Ra—I | | |
| B—O, As—O, Po—O, Be—N, Al—N, Ti—N, Ta—N, Mn—N, Be—Cl, Al—Cl, Ti—Cl, Ta—Cl, Mn—Cl, | 43% | |
| Se—Br, Hf—Br, Th—Br, Li—C, Ca—C, Sr—C, Li—S, Ca—S, Sr—S, Li—I, Ca—I, Sr—I | | |
| P—O, Te—O, Nb—N, V—N, Cr—N, Zn—N, Ga—N, Nb—Cl, V—Cl, Cr—Cl, Zn—Cl, Ga—Cl, Zr—Br, | 39% | |
| Pa—Br, U—Br, Ac—C, lanthanoid-C, Ac—S, lanthanoid-S, Ac—I, lanthanoid | | |
| Ru—O, Os—O, Rh—O, Ir—O, Pd—O, Pt—O, At—O, W—N, Cd—N, In—N, W—Cl, Cd—Cl, | 35% | |
| In—Cl, Be—Br, Al—Br, Ti—Br, Ta—Br, Mn—Br, Mg—C, Y—C, Cs—C, Fr—C, Mg—S, Y—S, | | |
| Cs—S, Fr—S, Mg—I, Y—I, Cs—I, Fr—I | | |
| Mo—N, Fe—N, Ti—N, Si—N, Ge—N, Sn—N, Mo—Cl, Fe—Cl, Tl—Cl, Si—Cl, Ge—Cl, Sn—Cl, | 30% | |
| Nb—Br, V—Br, Cr—Br, Zn—Br, Ga—Br, Se—C, Hf—C, Th—C, Se—S, Hf—S, Th—S, | | |
| Se—I, Hf—I, Th—I | | |
| General Substances including Hydroxyl Group | | due to the inclusion of |
| | | hydroxyl group |
| Oxides in General | | due to surface being |
| | | termed to include |
| | | hydroxyl |
| Water-Soluble Substances in General | | due to being soluble in |
| | | water |
| Some Specific Oxides (e.g., Titanium oxide, zinc oxide) | | due to photo-excitation |

And in the first process, due to the heat of the heater 7 being pre-controlled by the temperature control system 9, the temperature of the surface 10 of the through-hole 1 is kept higher than the evaporating temperature of the aqueous solution L, and lower than the melting temperature of the lubricant beforehand. Then, the automatically openable and closable valve is opened to apply the aqueous solution L of the lubricant by spraying from the spray member 6 to the molding portion 1A of the die 2 heated by the heater 7, with the lower punch 3 being fitted into the through-hole 1 to define the molding portion 1A. At this moment, the angle X of contact of the aqueous solution L, which would be the angle Y of contact without the surface treatment layer 11, is allowed to be the smaller angle X of contact owing to the surface treatment layer 11, thus allowing the aqueous solution L to be prevented from being repelled, to thereby the aqueous solution L is applied to the entire surface of the though-hole 1 and wet the same. As a result, the aqueous solution L is evaporated and dried out, and thus crystals are allowed to grow entirely on the surface treatment layer 11 of the through-hole 1, so that a crystallized layer B serving as a lubricating layer of the lubricant is uniformly formed.

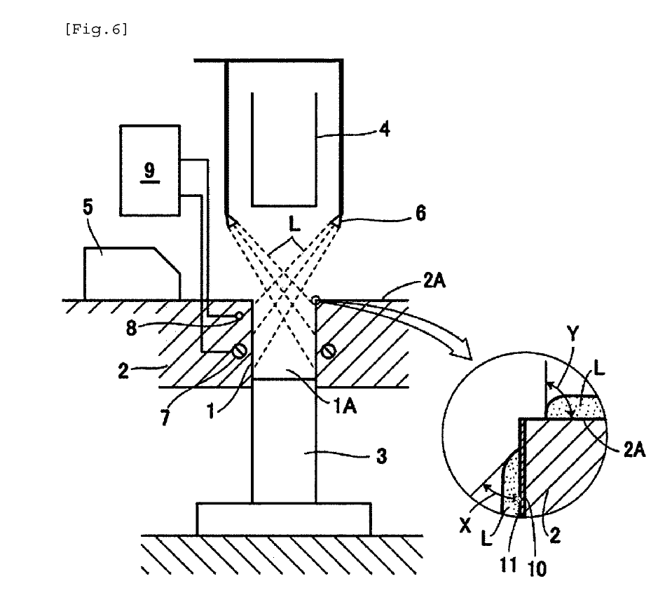

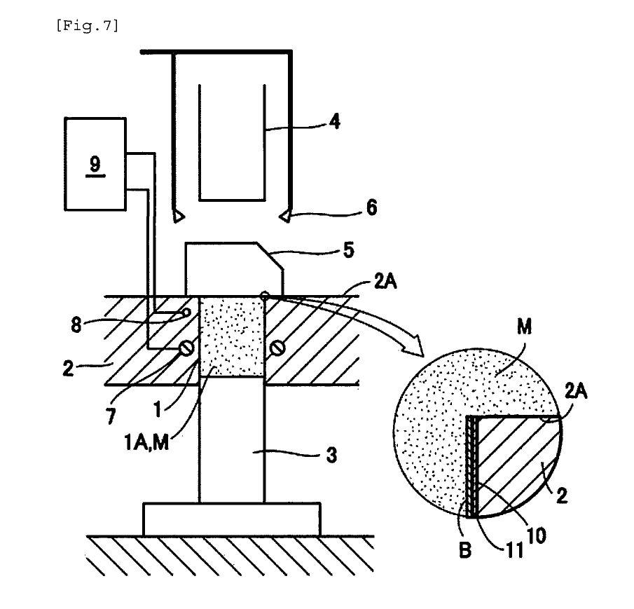

Next, as illustrated in a second process shown in FIG. 6, the feeder 5 is moved forward so as to drop a raw powder M into the molding portion 1A to fill the same therewith. Subsequently, as illustrated in a third process shown in FIG. 7, the die 2 is moved downwardly, while the upper punch 4 is inserted into the molding portion 1A of the through-hole 1 from there above, so that the raw powder M is compressed in a manner that is sandwiched between the upper punch 4 and the lower punch 3. At this stage, a bottom end of the lower punch 3 is firmly held in position. In this third process, the raw powder M is compressed by being pressed against the crystallized layer B which is formed by lubricant in a lubricated condition.

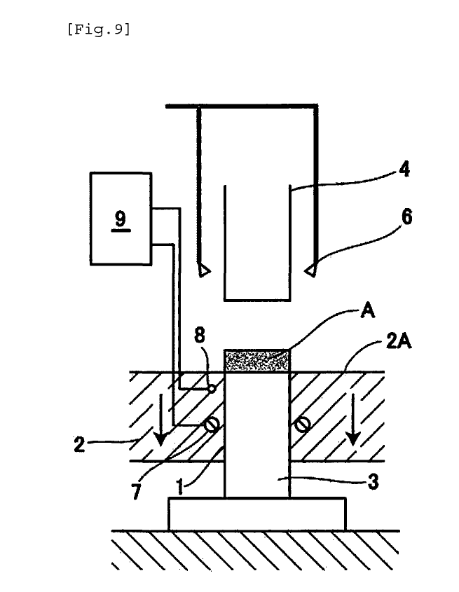

The powder molding product A thus press-molded becomes ejectable when the die 2 is moved further downwardly until the upper surface of the die 2 becomes essentially as high as the upper surface of the lower punch 3, as illustrated in a fourth process shown in FIG. 9. When ejecting the same, the powder molding product A is allowed to contact the crystallized layer B which is formed by lubricant in a lubricated condition. After ejecting the powder molding product A thus way, the first process is repeated and thus the aqueous solution L is applied to the molding portion 1A again to form the crystallized layer B, and then the raw powder M is filled into the molding portion 1A.

As is apparent from the foregoing, the surface 10 of the through-hole 1 is formed with the surface treatment layer 11 so as to have the smaller angle X of contact with the aqueous solution L than the angle Y of contact of the die 2 with the aqueous solution L, in accordance with the foregoing experiment. Thus, when the aqueous solution L is applied, the wetting action of the aqueous solution L relative to the surface 10 is improved so that the aqueous solution L can be extended over the surface treatment layer 11, eventually over the entire surface of the through-hole. Consequently, the entire surface of through-hole 1 can be formed with the crystallized layer B by performing water evaporation. As a result, high-density powder molding product A can be stably obtained.

### EXAMPLE 3

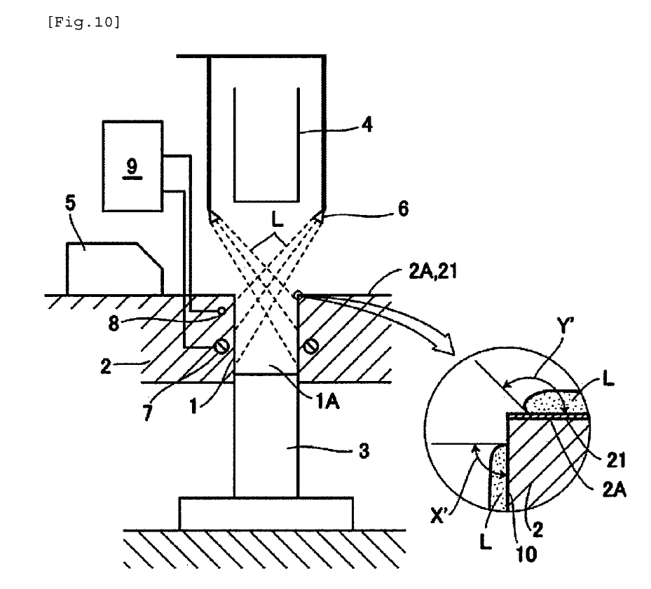

FIG. 9 and FIG. 10 represent Example 3, in which the same reference symbols as those in Example 1 and Example 2 will be designated by the same symbols, and their repeated detailed description will be omitted. According to the Example 2, the upper surface 2A of the die 2 on which feed 5 is slidably provided is formed with a surface treatment layer 21 by water repellency imparting treatment to the surface 2A for improving its liquid repelling ability (i.e., reducing the wetting action of the aqueous solution L) relative to the surface 2A, or by arranging water repellent material thereon. An angle Y′ of contact of the surface treatment layer 21 relative to the aqueous solution L is larger than an angle X′ of contact of the surface made from the material of the die 2 itself, or in Example 3 the surface 10 of the through-hole 1, relative to the aqueous solution L (Y′>X′), thus enabling the said wetting action to be reduced. The above surface treatment layer 21 may be formed from silicone- or fluorine-based resin such as those including Si—H bond, or C—H bond, etc., or from nonpolar substances, as shown in Table 5.

TABLE 5
Examples of Water Repellent Substances

| | Approximate | Principal Reason |
|---|---|---|
| | ionicity of | for Watwer |
| Water Repellent Bond elements or Water Repellent Substances | Bond | Repellency |
| Re—H, 1c-H, Co—H, Ni—H, Cu—H, Ag—H, Hg—H | 1% | due to small |
| Mo—H, Fe—H, 1L-H, Si—H | 3% | ionicity (polarity) |
| H—C, P—C, 1e-C, H—S, P—S, 1e-S, H—I, P—I, 1e-I, W—H, Cd—H, In—H | 4% | of Bonds |
| B—C, As—C, Po—C, B—S, As—S, Po—S, B—I, As—I, Po—I, Nb—H, V—H, Cr—H, Zn—H, Ga—H | 7% | |
| Re—C, 1c-C, Co—C, Ni—C, Cu—C, Ag—C, Hg—C, Pb—C, Sb—C, Bi—C, Re—S, 1c-S, | 9% | |
| Co—S, Ni—S, Cu—S, Ag—S, Hg—S, Pb—S, Sb—S, Bi—S, Re—I, 1c-I, Co—I, Ni—I, Cu—I, Ag—I, | | |
| Hg—I, Pb—I, Sb—I, Bi—I, Be—H, Al—H, 1i-H, 1a-H, Mn—H | | |
| Mo—C, Fe—C, 1l-C, Si—C, Ge—C, Sn—C, Mo—S, Fe—S, 1l-S, Si—S, Ge—S, Sn—S, | 11% | |
| Mo—I, Fe—I, 1l-I, Si—I, Ge—I, Sn—I, Zr—H, Pa—H, U—H | | |
| Nonpolar Substances in General | | due to being |
| | | nonpolar |

According to Example 3, therefore, the automatic open able and closable valve is opened so that the aqueous solution L of the lubricant is sprayed from the spray member 6 and applied to the molding portion 1A of the die 2 that is heated by the heater 7. At this moment, part of the aqueous solution L is likely to be attached to the upper surface 2A of the die 2. Nevertheless, the aforementioned angle Y′ of contact of the aqueous solution L with the upper surface 2A on which the surface treatment layer 21 is provided, becomes larger than the angle X′ of direct contact thereof with the die 2, whereby the aqueous solution L is allowed to be repelled, thus preventing the aqueous solution L to collect on the surface 2A.

As is apparent from the foregoing, since the upper surface 2A is formed with the surface treatment layer 21 so as to have the larger angle Y′ of contact with the aqueous solution L than the angle X′ of contact of the die 2 itself with the aqueous solution L, whereby the water repellent property on the upper surface 2A can be improved, making the aqueous solution L less likely to pile up or collect on the upper surface 2A (the surface treatment layer 21), thus preventing the aqueous solution L from collecting on the upper surface 2A (surface treatment layer 21), which in turn makes the raw powder M housed in the feeder 5 less likely to be contacted by the aqueous solution L, thereby enabling the raw powder M to be prevented from caking.

### EXAMPLE 4

FIG. 9 and FIG. 10 represent Example 4, in which the same reference symbols as those in Examples 1˜3 will be designated by the same symbols, and their repeated detailed description will be omitted.

According to example 4, above the through-hole 1 is provided the spray member 6 serving as applying means for spraying the aqueous solution L so as to attach the aqueous solution L to the molding portion 1A. The spray member 6 is arranged so as to face the through-hole 1. The aqueous solution L contains components which improve the wetting action relative to the surface 10 of the through-hole 1. The wetting action improving components are ones that can make the angle X″ of contact of the aqueous solution L with the surface 10 smaller, for example, surfactant is used.

Thus, the automatically open able and closable valve is opened to apply the aqueous solution L of the lubricant by spraying from the spray member 6 to the molding portion 1A of the die 2 heated by the heater 7, with the lower punch 3 being fitted into the through-hole 1 to define the molding portion 1A. At this moment, the angle X″ of contact of the aqueous solution L, which would become large without the wetting action improving components, is allowed to be small enough owing to the components, thus allowing the aqueous solution L to be prevented from being repelled, to thereby be applied to the entire surface 10 of the though-hole 1 and wet the same. As a result, the aqueous solution L is evaporated and dried out, and thus crystals are allowed to grow entirely around the surface of the through-hole 1, so that a crystallized layer B of the lubricant is uniformly formed.

As is apparent from the foregoing, since the aqueous solution L contains components which improve the wetting action in order to decrease the angle X″ of contact with the surface 10, the wetting action of the aqueous solution L in the through-hole 1 is improved when the aqueous solution L is applied, thus allowing the aqueous solution L to be extended over the entire surface of the though-hole 1, so that the aqueous solution L is evaporated to thereby allow the crystallized layer B to grow entirely, thus enabling the high-density powder molding product to be stably obtained.

Further, hereinafter examples and comparative examples will now be explained with reference to Table 6. In each of the examples and comparative examples shown in Table 6, iron powders (average particle diameter: 90 μm) were used as the raw powder, and 7 g of the mixture of the raw powder was filled into a mold forming a cylindrical column having a 1 cm² pressurization area, and then powder molding products were formed at a molding pressure of 8 t/cm². And in the preferred examples, 1% solution of dipotassium hydrogen phosphate as water-soluble lubricant was applied to the molding portion of the die coated with hydrophilic material and heated to 250° C., and then it was evaporated and dried out to form the crystallized layer, and then the raw powders were filled into this molding portion. In the comparative example 1, after the lubricant was applied to the molding portion of an ordinary die heated to 250° C., it was dried and then the raw powder was filled into this molding portion. In the comparative example 2, after the lubricant was applied to the molding portion of an ordinary die heated to 150° C., it was dried and then the raw powder was filled into the molding portion. The comparative example 3 is a case in which an ordinary die was heated to 150° C., and then the raw powder was filled into the molding portion without the application of lubricant. In either example, SKH-51 as typically employed for tool steel was used for the molding portion of such ordinary die.

TABLE 6

| | | | | | | | Comparative | Comparative | Comparative |
|---|---|---|---|---|---|---|---|---|---|
| | Example 1 | Example 2 | Example 3 | Example 4 | Example 5 | Example 6 | Example 1 | Example 2 | Example 3 |
| Hydrophilic | Al—O | Al—O | Ti—O | Al—O | Al—O | Al—O | None | None | None |
| Bond Element | Ti—O | | | Mg—O | Si—O | Ca—O | | | |
| Components of | Al₂O₃ | Al₂O₃ | TiO₂ | Spinel | Al₂O₃ | Al₂O₃ | None | None | None |
| Hydrophilic | 60% | | | | 60% | 60% | | | |
| Coating | TiO₂ | | | | SiO₂ | CaO | | | |
| | 40% | | | | 40% | 40% | | | |
| Process for | Spray | Spray | Spray | Spray | Spray | Spray | None | None | None |
| treatment of | coating | coating | coating | coating | coating | coating | | | |
| Hydrophilic | | | | | | | | | |
| Coating | | | | | | | | | |
| Lubrication of Mold | Yes | Yes | Yes | Yes | Yes | Yes | Yes | Yes | No |
| Molding | 250° C. | 250° C. | 250° C. | 250° C. | 250° C. | 250° C. | 250° C. | 150° C. | 150° C. |
| Temperature | | | | | | | | | |
| Molding | 7.68 g/cm³ | 7.67 g/cm³ | 7.68 g/cm³ | 7.67 g/cm³ | 7.68 g/cm³ | 7.67 g/cm³ | unformable | 7.58 g/cm³ | Unformable |
| Density | | | | | | | | | |

Comparison result from Table 6 indicates that molding was found impossible if it was performed at 250° C. using dies without the hydrophilic coating, due to the lubricant being nut fully attached to the molding portion. According to the Examples 1-6 where molding was performed, using dies with the hydrophilic coating, molding was found possible at temperature higher than 150° C., and it was found that high-density molding product denser than those formed at 150° C. can be obtained.

Further, the present invention is not limited to the forgoing embodiment but may be variously modified within the scope of the invention. In the foregoing embodiment, said aqueous solution is applied to the molding portion and then evaporated the aqueous solution to form the crystallized layer on the molding portion prior to filling the raw powder, and then the punches fitted into the molding portion to thereby forming the powder molding product, however, it is not always necessary to form the crystallized layer on the molding portion by applying the solution thereto and then evaporating the same, prior to filling the raw powder. For example, after forming a first powder molding product, a second powder molding product may be formed by filling a second raw powder, utilizing the crystallized layer formed when the first powder molding product is formed, without applying the aqueous solution to the molding portion, and then the aqueous solution may be applied to the molding portion prior to filling a third raw powder, and then the aqueous solution is evaporated, to thereby form a second crystallized layer on the molding portion. The aqueous solution may be applied to the molding portion in such an intermittent continuance.

1. A method for forming a powder molding product by filling a molding portion formed in a mold body with a raw powder and then fitting punches into the molding portion, comprising the steps of:
applying an aqueous solution obtained by dissolving a water soluble lubricant having at least 3 g of solubility for 100 g of water at 20° C. in water to the molding portion prior to filling the molding portion with a raw powder, and evaporating the aqueous solution to form a crystallized layer on the surface of the molding portion.

2. The method for forming a powder molding product according to claim 1, wherein said lubricant is an oxo-acid based metal salt.

3. The method for forming a powder molding product according to claim 1, wherein said lubricant is phosphate metal salt, sulfate metal salt, borate metal salt, silicate metal salt, tungstate metal salt, organic acid based metal salt, nitrate metal salt or carbonate metal salt.

4. The method for forming a powder molding product according to claim 3, wherein said lubricant is dipotassium hydrogen phosphate, disodium hydrogen phosphate, tripotassium phosphate, trisodium phosphate, potassium polyphosphate, sodium polyphosphate, riboflavin potassium phosphate and riboflavin sodium phosphate.

5. The method for forming a powder molding product according to claim 3, wherein said lubricant is potassium sulfate, sodium sulfate, potassium sulfite, sodium sulfite, potassium thiosulfate, sodium thiosulfate, potassium dodecyl sulfate, sodium dodecyl sulfate, potassium dodecyl benzen sulfate, sodium dodecyl benzene sulfate, Food Blue No. 1., Food Yellow No. 5., potassium ascorbyl sulfate ester and sodium ascorbyl sulfate ester.

6. The method for forming a powder molding product according to claim 3, wherein said lubricant is potassium tetraborate or sodium tetraborate.

7. The method for forming a powder molding product according to claim 3, wherein said lubricant is potassium silicate or sodium silicate.

8. The method for forming a powder molding product according to claim 3, wherein said lubricant is potassium tungstate or sodium tungstate.

9. The method for forming a powder molding product according to claim 3, wherein said lubricant is potassium acetate, sodium acetate, potassium benzoate, sodium benzoate, dipotassium terephthalate, disodium terephrhalate, potassium ascorbate, or sodium ascorbate.

10. The method for forming a powder molding product according to claim 3, wherein said lubricant is potassium nitrate or sodium nitrate.

11. The method for forming a powder molding product according to claim 3, wherein said lubricant is potassium carbonate, sodium carbonate, potassium hydrogen carbonate or sodium hydrogen carbonate.

12. The method for forming a powder molding product according to claim 1, wherein said lubricant uses at least two lubricants.

13. The method for forming a powder molding product according to claim 2, wherein said aqueous solution is the one in which said water soluble lubricant is completely dissolved in water to have a concentration greater than or equal to 0.01% by weight concentration but less saturated concentration.

14. The method for forming a powder molding product according to claim 13, wherein the lubricant is potassium salt or sodium salt.

15. The method for forming a powder molding product according to claim 2, wherein that an antiseptic substance is added into said lubricant.

16. The method for forming a powder molding product according to claim 2, further comprising the step of adding a defoaming agent into the lubricant.

17. The method for forming a powder molding product according to claim 2, further comprising the step of adding a water soluble solvent is added into the lubricant.

18. The method for forming a powder molding product according to claim 17, wherein said solvent is alcohol or ketone.

19. The method for forming a powder molding product according to claim 2, wherein a halogen element is excluded from the lubricant.

20. A mold apparatus for powder molding, comprising:
a mold body with a through-hole for forming a side of the powder molding product,
a lower punch to be fitted into the through-hole from beneath,
an upper punch to be fitted into the through-hole from above,
a spray member from which a lubricant aqueous solution is faced into the through-hole,
a heater provided around a molding portion of the powder molding product, the molding portion being defined by the through-hole and the lower punch which is fitted into the through-hole,
a temperature control system keeping a temperature of the heater higher than an evaporating temperature of the aqueous solution, and
an aqueous solution in which water soluble lubricant having at least 3 g of solubility for 100 g of water at 20° C. is dissolved in water, is provided in said spray member.

21. A mold apparatus for powder molding, comprising:
a mold body with a through-hole for forming a side of the powder molding product,
a lower punch to be fitted into the through-hole from beneath,
an upper punch to be fitted into the through-hole from above,
a spray member from which a lubricant aqueous solution is faced into the through-hole,
a heater provided around a molding portion of the powder molding product, the molding portion being defined by the through-hole and the lower punch which is fitted into the through-hole,
a temperature control system keeping a temperature of the heater higher than an evaporating temperature of the aqueous solution, but lower than melting temperature of said lubricant, and,
an aqueous solution in which water soluble lubricant having at least 3 g of solubility for 100 g of water at 20° C. is dissolved in water, is provided in said spray member.
